(19) United States
(12) Patent Application Publication
(10) Pub. No.: US 2005/0183245 A1
(43) Pub. Date: Aug. 25, 2005

(54) Line-securing device

(76) Inventor: Steven M. Whipple, Orlando, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/783,051

(22) Filed: Feb. 20, 2004

(51) Int. Cl. F16G 11/00

(52) U.S. Cl. 24/129 R

(57) ABSTRACT

A system for securing a line securely around an object, the system comprising a main body with holes to receive ends of the line and a plurality of protrusions within the holes allowing the line ends to enter the holes in a first direction and exit the holes in a second direction.

### BACKGROUND OF THE INVENTION

This invention relates to a fastening device, and more particularly to a fastening device to assist in securing ends of a piece of binding material, such as a rope together.

The invention stems from an idea, which occurred while a homeowner was cleaning house, and wanted to quickly fasten line, twine, and/or rope around numerous boxes, piping, shrubs, and other objects. However, easily containing such items with the line was time-consuming, cumbersome and awkward since it was hard to secure the line tightly around the objects.

From the inventor's observation, other tying devices to date proved too expensive, mechanized or restricting to accomplish the desired task. Additionally, it was found that time wasted with tying knots in rope was not conducive to ease or productivity. Moreover, it was desired to have an item that could be disposed, or reused in other applications.

Several devices have been designed for tying and securing lines. However, none possess disposable characteristics, or single-part gripping and staying action of the current embodiment disclosed herein.

### BRIEF DESCRIPTION OF THE INVENTION

The present invention gives a user freedom in selecting any myriad of objects, to be quickly and securely grouped together for storage, transport or disposal. Additionally it affords the user to choose any thickness of common twine or rope, without the need for knotting, looping, wrapping, winding, or tying. The embodiment was fashioned with consumer frugality in mind, whereas it is cost-effective enough to be disposed after a single use, but durable enough to be reused. The invention affords the user the ability to single-handedly group and tie objects, using nearly any given line media. With one-pull action, the line is held tightly in place. As many or as few objects may be grouped together, thus reducing the amount of labor and time involved in the overall binding, moving and storing process.

Towards this end, a system for securing a line securely around an object, or objects, is disclosed. The system comprises a main body with holes to receive ends of the line and a plurality of protrusions within the holes allowing the line ends to only enter the holes in a first direction and exit the holes in a second direction. In another exemplary embodiment an apparatus for securing a line securely around an object or objects, is disclosed. The apparatus comprises a receptacle for receiving an end of the line, a plurality of protrusions extending from the receptacle preventing the line from exiting the receptacle in a direction the line enters the receptacles, and a main body that holds the receptacles and the protrusions stationary.

The invention also discloses a leverage device to assist the user with tightly securing the line around an object to be secured. The invention further discloses an insertion device that can be used to assist the user with passing the line through the present invention and with assisting the user to remove the line from within the present invention.

### BRIEF DESCRIPTION OF THE DRAWINGS

The invention will be better understood when consideration is given to the following detailed description taken in conjunction with the accompanying drawings in which:

FIG. 1 is an isometric view of an exemplary embodiment of the present invention, showing the line “insertion” side of the embodiment;

FIG. 2 is an isometric view of an exemplary embodiment of the present invention, showing the line “exertion” side of the embodiment;

FIG. 3 is a side view of an exemplary embodiment of the present invention;

FIG. 4 is an isometric view of an exemplary embodiment of the present invention, showing hollowed out segments of a main body;

FIG. 5 is an exemplary embodiment of a spire view from an exertion side of the present invention;

FIG. 6 illustrates several uses of an exemplary embodiment, and applications thereof of the present invention;

FIG. 7 illustrates an exemplary embodiment of a leverage device;

FIG. 8 illustrates an exemplary embodiment of a leverage device connected to a main body;

FIG. 9 illustrates a use of an exemplary embodiment of the present invention;

FIG. 10 is an illustration of an exemplary embodiment of an insert sleeve device being used with a main body of the present invention; and

FIG. 11 is an illustration of an exemplary embodiment of an insert sleeve device.

### DETAILED DESCRIPTION OF THE INVENTION

The present invention may be broadly utilized with various types of binding material, such as but not limited to a line, twine, rope, chain, leather, etc. For purposes of illustration, the invention is described herein as it may be applied to a line. Before describing in detail the present invention, it should be observed that the present invention resides primarily in a novel combination of components related thereto. Accordingly, the device has been represented by conventional elements in the drawings, showing only those specific details that are pertinent to the present invention, so as not to obscure the disclosure with structural details that will be readily apparent to those skilled in the art having the benefit of the description herein. Additionally, the phraseology and terminology employed herein are for the purpose of description and should not be regarded as limiting.

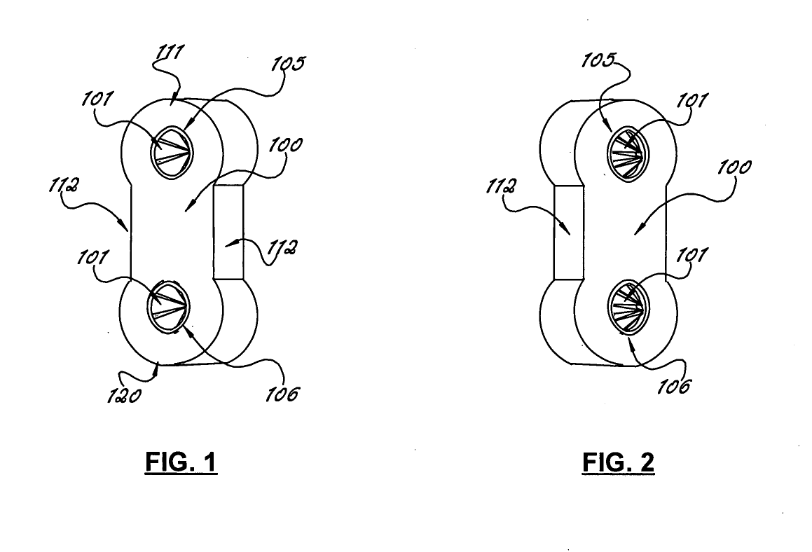

In an exemplary embodiment, as illustrated in FIGS. 1 & 2, a main body 100 is symmetrically shaped, with two (semi-circular) arcs, one at each end 111, 120, and perpendicular sides 112 that intersect the tangent of the arcs. The dimensions of the main body 100 are proportionate to its length, width, and thickness or depth, as is necessary to secure a given thickness of line.

Located at either end of the main body 100 are holes 105, 106 which contain unidirectional protrusions, or “spires”, 101. The spires 101 are narrow, elongated and angled to lock a line 130 securely into place, as further illustrated in FIG. 3. In an exemplary embodiment (not shown), the entrance side to the holes, 105, 106 that the line is fed through is smaller than the exit side from which the line 130 exits. This is to allow for the line to have room for clearance and expansion when a user is securing ends of the line together with the present invention.

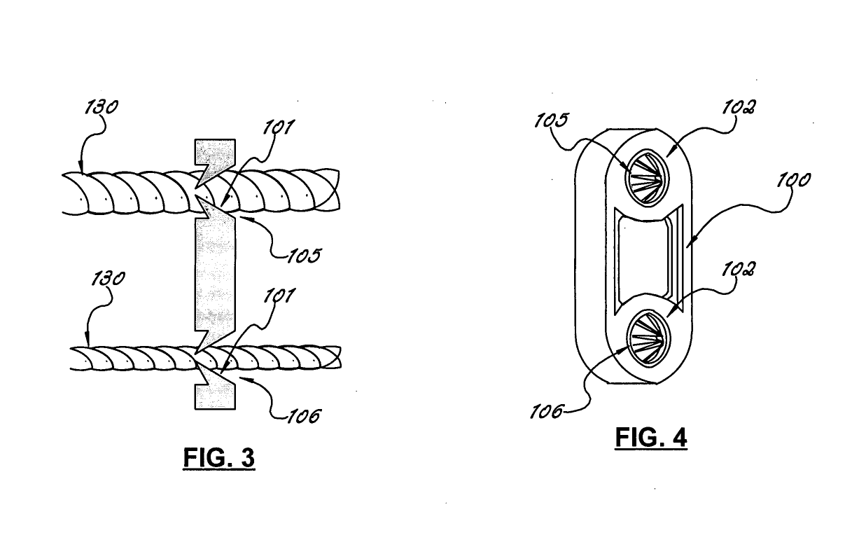

In an exemplary embodiment, as illustrated in FIG. 4, the main body 100 is hollowed, either partially or completely for the purpose of conserving material during manufacturing. Additionally, the hollowing may be of a size or shape that will promote consistency during the molding or remolding process of the main body 100.

The total number, frequency, amount, size, thickness, and angles of the spires 101 that shall be incorporated into the spire holes 105, 106 is neither finite nor infinite, so to accommodate various types of production material used in the manufacturing process thereof. There shall be no preference made to the symmetry of either spire hole 105, 106 with respect to the other, or the spires 101 therein. Additionally, neither symmetry nor shape of the preferred embodiment shall be limited, rather it shall assume the most practical appearance as is required to achieve the manufacturing, molding or remolding objective of the present invention.

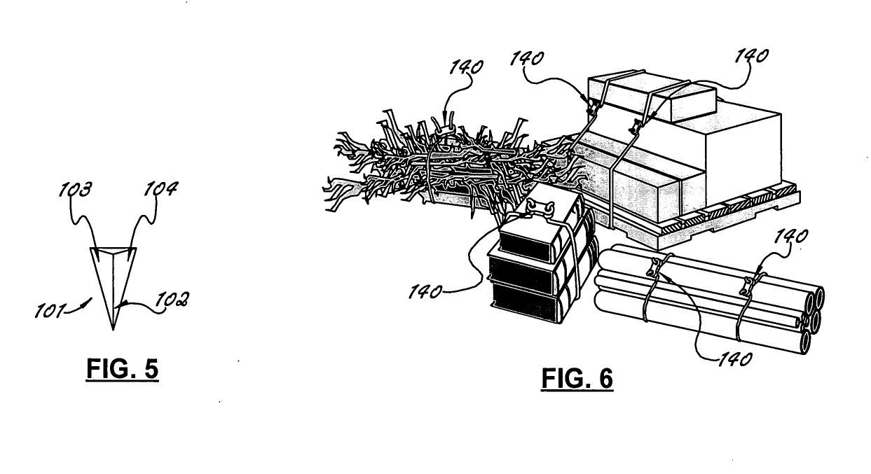

In an exemplary embodiment, as illustrated in FIG. 5, the spires 101 are triangular in shape. Each spire 101 possesses flexibility to it so that during line insertion, each spire 101 is able to bite into the line 130, thus prohibiting reverse motion of the line 130 once insertion has begun. The spire 101 has a spine 102, on the exertion side of the spire 101 that gives the spire 101 this locking ability, while the adjoining sides 103, 104 provides the spire with strength and staying power. Spacing between the spires 101 allows forward motion to take place during insertion of the line 130.

As illustrated in FIG. 6, any myriad of objects that can be grouped together with a line 130 can be secured together using the present invention. In operation, the line is wrapped around the objects, and either end of the line is inserted into the holes 105, 106 of the main body 100, and pulled tightly. The gripping action of the spires 101 grips the rope and fastens it automatically. Once the first line is secured in the main body 100, the second end of the line is inserted in the remaining hole 105, 106 of the main body 100 and is similarly secured.

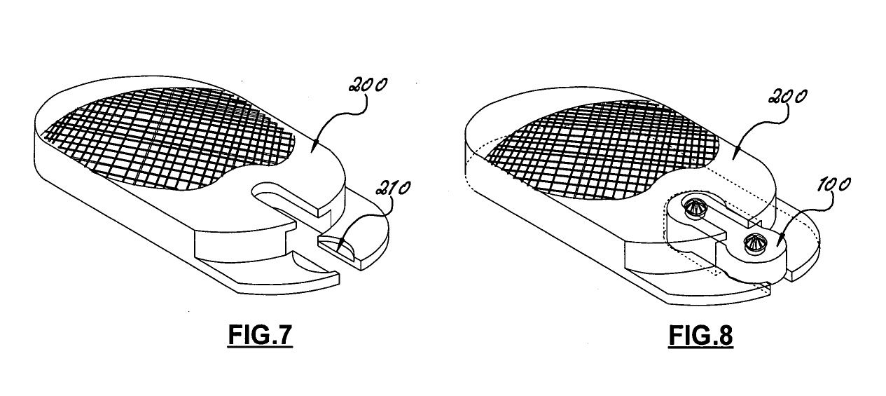

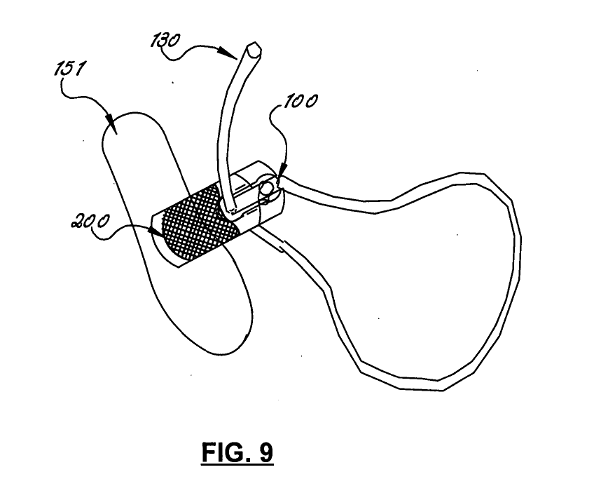

As illustrated in FIGS. 7 & 8, a leverage device 200 is provided where the main body 100 can fit within it. In one embodiment, the leverage device 200 and main body 100 are a single element. In another exemplary embodiment, the leverage device 200 and main body 100 are separate elements that connect together. A cavity 210 is provided in the leverage device 200 to receive and hold the main body 100. In this embodiment, as illustrated in FIG. 9, once a user uses the leverage device 200, by placing a foot 151 on it to hold the devices 100, 200, and objects being bundled secure, and finally secures the objects, the leverage device 200 can be disconnected from the main body.

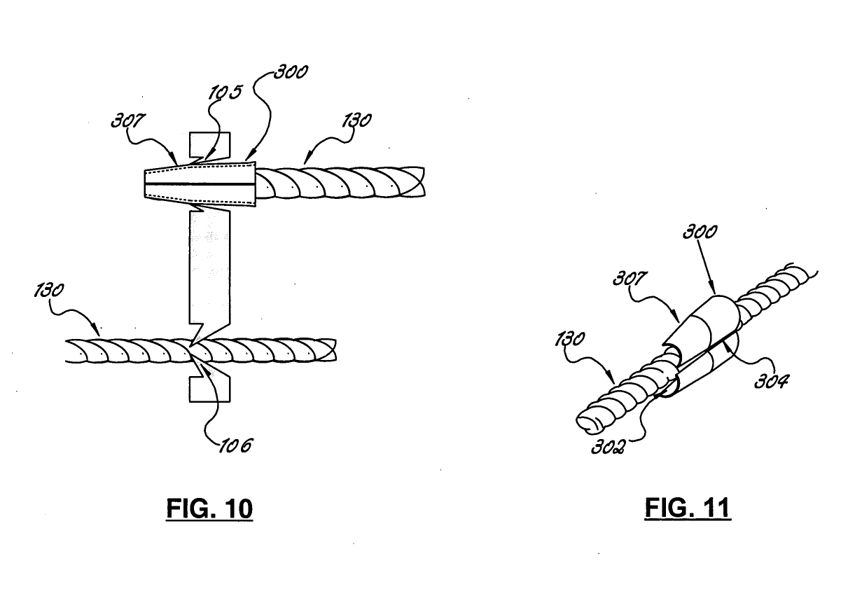

As illustrated in FIGS. 10 & 11, in another exemplary embodiment, the present invention is reusable. An insertion device, or insert sleeve, 300 is provided that fits around the line 130. The insert sleeve 300 is provided to promote passing the line 130 through the holes 105, 106. The length of the insert sleeve 300 can vary. In one embodiment, the length is approximately an inch long. The insert sleeve 300 is useful when line 130 is used that is not easily passed through the holes 105, 106. In one preferred embodiment, spires 302 are inside of the part of the insert sleeve 300 that connects with the line 130.

The insert sleeve 300 is allowed to fully pass through either hole 105, 106 that it is fed through. In operation, as further illustrated in FIG. 11, the insert sleeve 300 is placed around the line 130 prior to inserting the line 130 into either hole 105, 106 of the main body 100. To be placed around the line 130, the insert sleeve 300 is opened laterally along a side of the insert sleeve wherein the line 130 is then placed within the insert sleeve 300. For line 130 that is hard to pass through a hole, 105, 106, the insert sleeve 300 is placed at an end of the line 130. The line 130, inside of the insert sleeve 300 is then passed through the hole 105, 106. Once through the hole 105, 106, the user is now able to grab the line 130 to continue pulling it through the hole 105, 106 until tightened around an object being bound. The user has the option of leaving the insert sleeve 300 around the line 130 or removing-it once the line 130 has passed through the hole 105, 106. In an exemplary embodiment, the insert sleeve 300 has a solid outer surface or wall.

As further illustrated in FIG. 10, the spires 101 within the holes 105, 106 engage an outer surface of the insert sleeve 300. In a preferred embodiment, the outside surface 307 of the insert sleeve 300 that connects with the spires 101 is permitted to slide easily through the holes 105, 106 of the main body 100. As further illustrated, the insert sleeve 300 can be used with either end of the line 130 to promote easy insertion of the line 130 through either hole 105, 106. Furthermore, in the hole 105, 106 that the insert sleeve 300 is used, the spires 101 of the hole 105, 106 are not so rigid that they will make direct contact with the line 130, so that when the user desires to release the insert sleeve 300 from the hole 105, 106 the spires 101 will give way to allow the insert sleeve 300 to be released.

In another preferred embodiment, the insert sleeve 300 can be used in aiding with removing the line 130 from the holes 105, 106. Once an object is bound using the present invention, the user can fit the insert sleeve around the part of the line 130 that has not passed through the hole 105, 106. The insert sleeve 300 is placed around the line 130 so that the spires 302 inside the insert sleeve are in the opposite direction than they would be if the user were using the insert sleeve to insert the line into the hole 105, 106. The user can then guide the insert sleeve 300 into the hole 105, 106 until the insert sleeve 300 pushes against the spires 101 side of the hole 105, 106, which will release the spires 101 from the line 130. Once the spires are released, the user can freely pull the line 130 from the holes 105, 106.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A system for securing a first end and a second end of a line wherein said line is placed around an object, said system comprising:
(a) a main body;
(b) a first hole formed therethrough said main body through which said first end of said line is inserted;
(c) a second hole formed therethrough said main body through which said second end of said line is inserted;
(d) a plurality of protrusions within said first hole and said second hole allowing, within said first hole, said first end of said line to enter in a first direction and exit in a second direction and within said second hole allowing said second end of said line to enter in a first direction and exit in a second direction; and
(e) a third hole formed therethrough said main body through which at least one of said first end or said second end of said line may be further secured to said main body.

2. The system of claim 1 wherein each of said plurality of protrusions comprise a spine that prevents said line to exit said holes in said first direction.

3. The system of claim 1 wherein said protrusions are angled within each of said first hole and said second hole to create wider holes at a first end where said line is received and narrower holes at a second end where each of said lines exit each of said holes.

4. The system of claim 1 wherein said main body is symmetrically shaped having two semi-circular arcs, one at each end of said main body and having perpendicular sides that intersect a tangent of said arcs wherein said first hole, said second hole, and said third hole are in a same plane.

5. The system of claim 1 further comprising a leverage device connected to said main body.

6. The system of claim 4 wherein said leverage device further comprises a cavity for receiving and holding said main body.

7. The system of claim 4 wherein said leverage device and said main body are a single element.

8. The system of claim 1 further comprising an insertion device that fits around said line.

9. The system of claim 8 wherein said insertion device further comprises an external surface to engage said plurality of protrusions allowing said insertion device to move one direction within said holes.

10. The system of claim 8 wherein said insertion device further comprises a plurality of protrusions on an inner surface of said insertion device that connects to said line that allow said line ends to enter said insertion device in a first direction and exit said insertion device in a second direction.

11. The system of claim 10 wherein said insertion device fits around said line and is held in place by said plurality of protrusions.

12. The system of claim 8 wherein said insertion device is placed around a part of said line that has not passed through one of said holes and is used to release said line from one of said holes in said first direction.

13. An apparatus having a main body for securing a line securely around an object, said system comprising:
(a) a first receptacle for receiving a first end of said line;
(b) a second receptacle for receiving a second end of said line;
(c) a plurality of protrusions extending from each of said first and second receptacles Preventing each end of said line from exiting each of said first and second receptacles in a direction each of said line ends enter each of said first and second receptacles;
(d) a third receptacle for further securing at least one of said first end or said second end of said line around an outer edge of said third receptacle; and
(e) wherein said third receptacle is centrally located in a same plane between said first receptacle and said second receptacle within said main body.

14. The apparatus of claim 13 further comprising a leverage device connected to said main body.

15. The apparatus of claim 14 wherein said leverage device further comprises a cavity for receiving and holding said main body.

16. The apparatus of claim 13 further comprising an insertion device comprising a circular wall that fits around said line with an external surface to engage said plurality of protrusions extending from said receptacle.

17. The apparatus of claim 16 wherein said insertion device further comprises a plurality of protrusions within said circular wall that allow said end of said line to enter said insertion device in a first direction and exit said insertion device in a second direction.

18. The apparatus of claim 17 wherein said insertion device further comprises a lateral opening for placement of said line within said circular wall.

19. The apparatus of claim 18 wherein said insertion device is placed around a part of said line that has not passed through one of said receptacles to allow said insertion device to be pushed into one of said receptacles releasing said protrusions from around said line and allowing said line to exit one of said receptacles in a direction said line enters one of said receptacles.
